(19) United States
(12) Patent Application Publication
(10) Pub. No.: US 2026/0192422 A1
(43) Pub. Date: Jul. 9, 2026

(54) TORQUE ADJUSTMENT INTERFACE FOR POWER TOOL

(71) Applicant: MILWAUKEE ELECTRIC TOOL CORPORATION, Brookfield, WI (US)

(72) Inventor: Alejandro M. Damonte Vegas, Glendale, WI (US)

(21) Appl. No.: 19/128,066

(22) PCT Filed: Nov. 7, 2023
(86) PCT No.: PCT/US2023/036957

§ 371 Date: May 7, 2025

Related U.S. Application Data
(60) Provisional application No. 63/382,627, filed on Nov. 7, 2022.

(51) Int. Cl. B25B 23/147; B25B 21/02; B25F 5/00; B25F 5/02

(52) U.S. Cl. CPC B25B 23/1475; B25F 5/001; B25F 5/02; B25B 21/02

(57) ABSTRACT

A power tool may include a housing including a motor housing portion, a front housing portion coupled to the motor housing portion, and a handle portion extending from the motor housing portion. The power tool may include a trigger coupled to a front side of the handle portion. The power tool may include an output member extending from the front housing portion. The power tool may include a torque adjustment interface disposed between the front housing portion and the trigger, the torque adjustment interface including an actuator rotatable in a first direction to increase a torque output limit of the power tool and in a second direction opposite the first direction to decrease the torque output limit of the power tool.

### CROSS-REFERENCE TO RELATED APPLICATIONS

This application claims priority to U.S. Provisional Patent Application No. 63/382,627, filed Nov. 7, 2022, the entire content of which is incorporated herein by reference.

### BACKGROUND

The present disclosure relates to power tools, and, more particularly, to torque adjustment interfaces for power tools.

### SUMMARY

In some aspects, the techniques described herein relate to a power tool including: a housing including a motor housing portion, a front housing portion coupled to the motor housing portion, and a handle portion extending from the motor housing portion; a trigger coupled to a front side of the handle portion; an output member extending from the front housing portion; and a torque adjustment interface disposed between the front housing portion and the trigger, the torque adjustment interface including an actuator rotatable in a first direction to increase a torque output limit of the power tool and in a second direction opposite the first direction to decrease the torque output limit of the power tool.

In some aspects, the techniques described herein relate to a power tool, wherein the actuator includes a rotatable dial case, and wherein the torque adjustment interface further includes a circuit board.

In some aspects, the techniques described herein relate to a power tool, wherein the circuit board is positioned within the dial case.

In some aspects, the techniques described herein relate to a power tool, wherein the circuit board is positioned between the dial case and the trigger.

In some aspects, the techniques described herein relate to a power tool, further including a potentiometer positioned within the dial case, wherein the potentiometer is configured to rotate with the dial case, and wherein the potentiometer is configured to send signals to the circuit board in response to rotation of the potentiometer.

In some aspects, the techniques described herein relate to a power tool, wherein the circuit board includes an aperture, the dial case includes a post, and the post is received in the aperture and configured to rotate relative to the aperture.

In some aspects, the techniques described herein relate to a power tool, wherein the torque adjustment interface further includes a support positioned within the dial case, the support includes an arm in contact with an inner surface of the dial case, and the arms is configured to provide tactile feedback as the dial case rotates relative to the support.

In some aspects, the techniques described herein relate to a power tool, further including a detent assembly disposed in the housing and configured to contact an outer wall of the dial case to resist rotation of the dial case.

In some aspects, the techniques described herein relate to a power tool, wherein the detent assembly includes a detent housing, a biasing member positioned in the detent housing, and a ball positioned within the detent housing and biased by the biasing member, the ball is configured to contact the outer wall of the dial case, and rotation of the dial case is configured to move the ball against a bias of the biasing member.

In some aspects, the techniques described herein relate to a power tool, wherein the housing includes a first clamshell defining a first lateral side of the housing and a second clamshell defining a second lateral side of the housing, and wherein the actuator is accessible from both the first lateral side and the second lateral side.

In some aspects, the techniques described herein relate to a power tool, wherein the actuator includes a rocker switch.

In some aspects, the techniques described herein relate to a power tool, further including a motor supported within the motor housing portion; a drive assembly supported within the motor housing portion and driven by the motor; and an impact assembly coupled to an output of the drive assembly, the impact assembly operable to deliver periodic rotational impacts to the output member, wherein the impact assembly is supported within the front housing portion.

In some aspects, the techniques described herein relate to a power tool including: a housing including a motor housing portion, a front housing portion coupled to the motor housing portion, and a handle portion extending from the motor housing portion; a motor supported within the motor housing portion; a drive assembly supported within the motor housing portion and driven by the motor; an impact assembly coupled to an output of the drive assembly, the impact assembly operable to deliver periodic rotational impacts to an output member extending from the front housing portion; and a torque adjustment interface including an actuator rotatable in a first direction to increase a torque output limit of the power tool and in a second direction opposite the first direction to decrease the torque output limit of the power tool.

In some aspects, the techniques described herein relate to a power tool, wherein the torque adjustment interface includes a circuit board, and wherein the actuator includes a portion extending through the circuit board.

In some aspects, the techniques described herein relate to a power tool, wherein the torque adjustment interface includes a potentiometer coupled for co-rotation with the actuator.

In some aspects, the techniques described herein relate to a power tool, wherein the actuator includes a rocker switch.

In some aspects, the techniques described herein relate to a power tool, wherein the housing includes a first clamshell defining a first lateral side of the housing and a second clamshell defining a second lateral side of the housing, and wherein the actuator is accessible from both the first lateral side and the second lateral side.

In some aspects, the techniques described herein relate to a power tool, wherein the actuator is located at a position selected from a group consisting of: a rear side of the motor housing portion opposite the front housing portion, a foot of the housing disposed at an end of the handle portion opposite the motor housing portion, a top side of the motor housing portion opposite the handle portion, and a chin portion of the housing below the front housing portion and above a trigger of the power tool.

In some aspects, the techniques described herein relate to a power tool including: a housing including a motor housing portion, a front housing portion coupled to the motor housing portion, and a handle portion extending from the motor housing portion; a motor supported within the motor housing portion; an output member extending from the front housing portion and rotatable about an axis; a torque adjustment interface including an acceleration sensor; and a control system configured to detect rotation of the housing about the axis based on feedback from the acceleration sensor, increase a torque output limit of the power tool if the housing is rotated about the axis in a first direction, and decrease a torque output limit of the power tool if the housing is rotated about the axis in a second direction opposite the first direction.

In some aspects, the techniques described herein relate to a power tool, wherein the control system is configured to increase or decrease the torque output limit at a rate proportional to a magnitude of the detected rotation.

Other features and aspects of the disclosure will become apparent by consideration of the following detailed description and accompanying drawings.

### BRIEF DESCRIPTION OF THE DRAWINGS

FIG. 1 perspective view of a power tool including a torque adjustment interface according to an embodiment of the present disclosure.

FIG. 2 is an enlarged side view of the power tool of FIG. 1.

FIG. 3 is an exploded view of the torque adjustment interface of FIG. 1.

FIG. 4 is a perspective view of a dial of the torque adjustment interface of FIG. 3.

FIG. 5 is a side view of the torque adjustment interface of FIG. 3.

FIG. 6 a side cross-sectional view of the torque adjustment interface taken along a line 6-6 in FIG. 5.

FIG. 7 is a perspective view of a support according to another embodiment of the present disclosure.

FIG. 8 is another perspective view of the support of FIG. 7.

FIG. 9 is an enlarged cross-sectional view of the impact tool taken along a line 9-9 in FIG. 2.

FIG. 10 is a perspective view of a detent illustrated in FIG. 9.

FIG. 11 is a perspective view of a torque adjustment interface according to another embodiment of the present disclosure.

FIG. 12 is a cross-sectional view of the torque adjustment interface taken along a line 12-12 in FIG. 11, the torque adjustment interface positioned in a power tool.

FIG. 13 is a perspective view of a power tool including a torque adjustment interface according to another embodiment of the present disclosure.

FIG. 14 is an enlarged perspective view illustrating the torque adjustment interface of FIG. 13.

FIG. 15 is an enlarged perspective view of the impact tool of FIG. 13 with a portion of the housing removed.

FIG. 16 is a perspective view of a rocker switch of the torque adjustment interface of FIG. 13.

FIG. 17 is a top view of the rocker switch of FIG. 16.

FIG. 18 is a perspective view of a circuit board of the torque adjustment interface of FIG. 13.

FIG. 19 is a perspective view of a power tool including a torque adjustment interface according to another embodiment of the present disclosure.

FIG. 20 is a perspective view of a power tool including a torque adjustment interface according to another embodiment of the present disclosure.

FIG. 21 is a perspective view of a power tool including a torque adjustment interface according to another embodiment of the present disclosure.

FIG. 22 is a perspective view of a power tool including a torque adjustment interface according to another embodiment of the present disclosure.

FIG. 23 is a perspective view of a power tool including a torque adjustment interface according to another embodiment of the present disclosure.

FIG. 24 is a perspective view of a power tool including a torque adjustment interface according to another embodiment of the present disclosure.

FIG. 25 is a perspective view of a power tool including a torque adjustment interface according to another embodiment of the present disclosure.

FIG. 26 is a perspective view of a power tool including a torque adjustment interface according to another embodiment of the present disclosure.

FIG. 27 is a perspective view of a power tool including a torque adjustment interface according to another embodiment of the present disclosure.

FIG. 28 is a perspective view of a power tool including a torque adjustment interface according to another embodiment of the present disclosure.

FIG. 29 is a perspective view of a power tool including a torque adjustment interface according to another embodiment of the present disclosure.

FIG. 30 is a perspective view of a power tool including a torque adjustment interface according to another embodiment of the present disclosure.

FIG. 31 is a perspective view of a power tool including a torque adjustment interface according to another embodiment of the present disclosure.

FIG. 32 is a perspective view of a power tool including a torque adjustment interface according to another embodiment of the present disclosure.

FIG. 33 is a perspective view of a power tool including a torque adjustment interface according to another embodiment of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways.

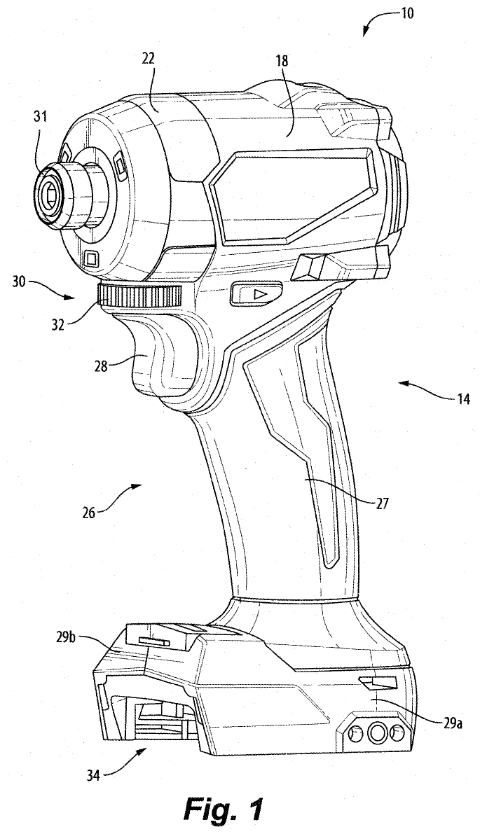

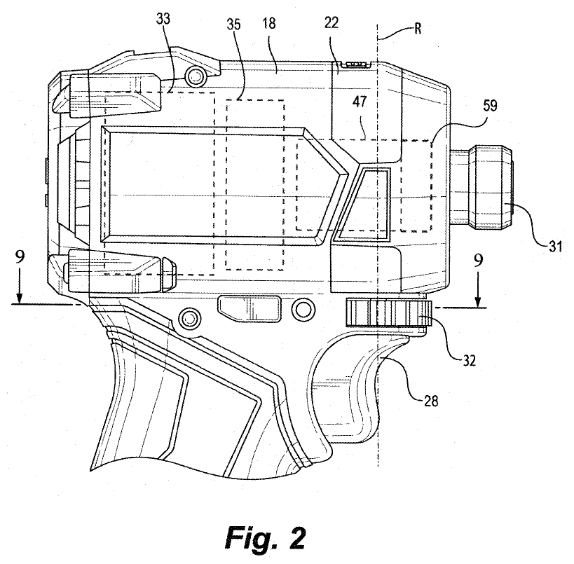

FIG. 1 illustrates a power tool 10 in the form of a rotary impact tool (e.g., an impact driver). The illustrated power tool 10 includes a housing 14 with a motor housing portion 18 enclosing a motor (e.g., a brushless DC motor 33; FIG. 2), a front housing portion or hammer case 22 coupled to the motor housing portion 18, and a handle portion 26 extending downwardly from the motor housing portion 18. The front housing portion 22 may be made of a different material (e.g., a structural metal such as steel, aluminum, etc.) than the motor housing portion 18 (e.g., a molded plastic material). In other embodiments, the front housing portion 22 may be made of the same material as the motor housing portion 18 and may be integral with the motor housing portion 18.

The handle portion 26 includes a grip 27 that can be grasped by a user. A trigger 28 is coupled to a front side of the handle portion 26 and can be actuated by the user to operate the power tool 10. In the illustrated embodiment, the handle portion 26 and the motor housing portion 18 are integral with one another and are defined by cooperating clamshell halves 29a, 29b. The front housing portion 22 is captured between the clamshell halves 29a, 29b. In other embodiments, the handle portion 26 and the motor housing portion 18 may be formed separately and coupled together in any suitable manner.

The illustrated power tool 10 has a battery receptacle 34 located on a foot of the housing at a bottom end of the handle portion 26 (i.e., opposite the motor housing portion 18). The battery receptacle 34 is configured to receive a battery pack (not shown), which provides power to the motor 33. In other embodiments, the power tool 10 may include a power cord for electrically connecting the power tool 10 to a source of AC power. As a further alternative, the power tool 10 may be configured to operate using a different power source (e.g., a pneumatic power source, etc.).

With reference to FIG. 2, the illustrated power tool 10 includes a drive assembly 35 driven by the motor 33 and an impact assembly 47 coupled to an output of the drive assembly 35. For example, the drive assembly 35 may include a planetary transmission with a ring gear, a plurality of planet gears meshed with the ring gear, and a planet carrier supporting the planet gears. The planet carrier may define the output of the drive assembly 35. The impact assembly 47 may include a camshaft coupled for co-rotation with the output of the drive assembly 35 and a hammer configured to reciprocate along the camshaft and deliver periodic rotational impacts to an anvil 31, which defines an output drive of the power tool 10. The illustrated anvil 31 extends from the front housing portion 22 and is configured to receive a tool bit, such as a screwdriver bit, socket, or the like, for performing work on a workpiece, such as tightening or loosening a fastener. The impact assembly 47 in the illustrated embodiment is at least partially received within and supported by the front housing portion 22, and the motor 33 and drive assembly 35 are at least partially received within and supported by the motor housing portion 18.

The power tool 10 includes an electronically-controlled clutch mechanism 59 configured to receive an electronic torque setting and electronically (e.g., via motor control) and/or mechanically (e.g., via an adjustable slip condition of the clutch mechanism) limit the torque output of the power tool 10 based on the torque setting. The illustrated power tool 10 is an impact driver. As such, the clutch mechanism 59 may be disposed between an impact-receiving portion of the anvil 31 and a tool bit attachment portion of the anvil 31 to selectively limit the transfer of torque therebetween. The clutch mechanism 59 may additionally or alternatively be configured in other ways to limit the torque output of the power tool 10, including but not limited to controlling the operating speed and/or torque output of the motor 33. The clutch mechanism 59 is adjustable via a torque adjustment interface, embodiments of which are described in further detail below. Although the illustrated power tool 10 is an impact driver including the impact assembly 47, in other embodiments, the power tool 10 may be a drill, powered screwdriver, or the like, and the impact assembly 47 may be omitted and replaced with a spindle coupled to (e.g., directly driven by) the output of the drive assembly 35.

In the illustrated embodiment, the power tool 10 includes a torque adjustment interface in the form of a rotary actuator or dial assembly 32 (FIGS. 1-2). The dial assembly 32 is located at least partially within a chin portion 30 of the power tool 10, defined between the front housing portion 22 and the trigger 28 (i.e., below the front housing portion 22 and above the trigger 28). The dial assembly 32 includes one or more components that are rotatable about a rotational axis R (FIG. 2) to adjust the torque setting of the power tool 10. In the illustrated embodiment, the rotational axis R intersects the front housing portion 22 and the trigger 28. As illustrated in FIGS. 1 and 2, the dial assembly 32 is accessible from both lateral sides, as well as the front of the power tool 10. In particular, more than 180 degrees (e.g., between 180 degrees and 270 degrees in some embodiments) of the circumference of the dial assembly 32 is accessible from the exterior of the housing 14 of the power tool 10. This allows the user to rotate the dial assembly 32 about a rotational axis R (e.g., using the user's index finger) while grasping the grip 27 of the power tool 10 with the same hand, thus facilitating one-handed, ambidextrous operation of the power tool 10.

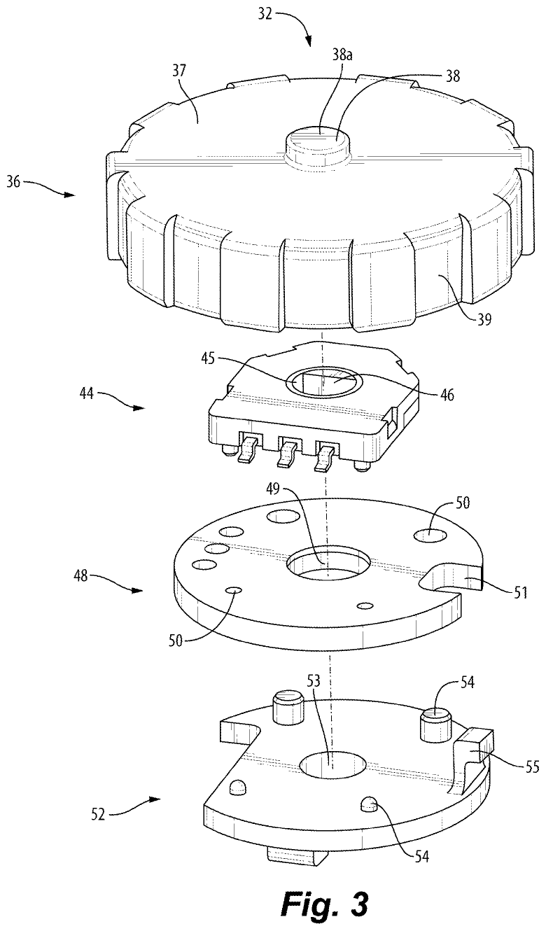

As illustrated in FIGS. 3 and 4, the dial assembly 32 includes a dial case 36, a potentiometer 44, a circuit board 48, which may be a printed circuit board (“PCB”), and a support 52. The dial case 36 includes a top wall 37, a central post 38 extending through the top wall 37, and an outer wall 39. A cavity 41 is defined by the top wall 37 and the outer wall 39, and a block 42 projects from the top wall 37 and the outer wall 39 into the cavity 41. The central post 38 includes a first portion 38a extending from a top surface of the dial case 36 and a second portion 38b extending from a bottom surface of the dial case 36. The first portion 38a is cylindrical in shape, and the second portion 38b is largely cylindrical with a flat side 43. The second portion 38b extends through a central aperture 45 of the potentiometer 44 and a central aperture 49 of the circuit board 48 and is received by a central recess 53 of the support 52. The central aperture 49 of the circuit board 48 and the central recess 53 of the support 52 are cylindrical, and the central aperture 45 of the potentiometer 44 is cylindrical with a flat side 46. The support 52 includes a plurality of bosses 54 and a stop tab 55 extending from a top surface of the support 52. The plurality of bosses 54 are received by apertures 50 in the circuit board 48 to secure the circuit board 48 to the support 52. The stop tab 55 extends through a cutout 51 in the circuit board 48.

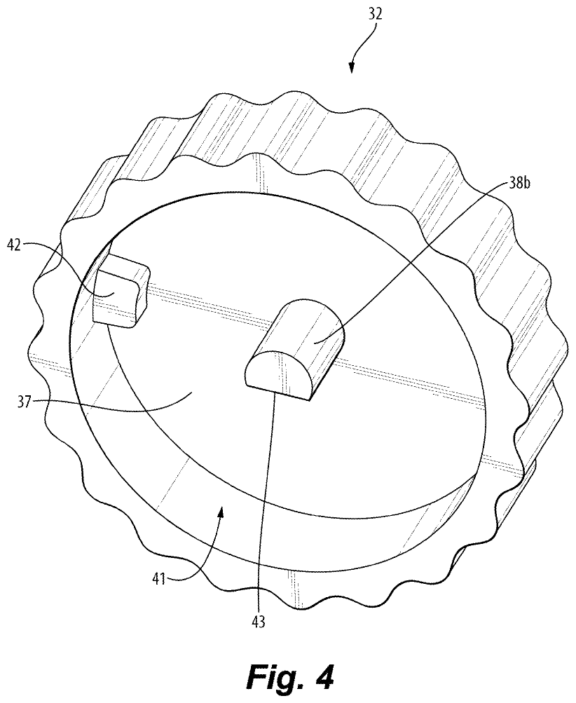

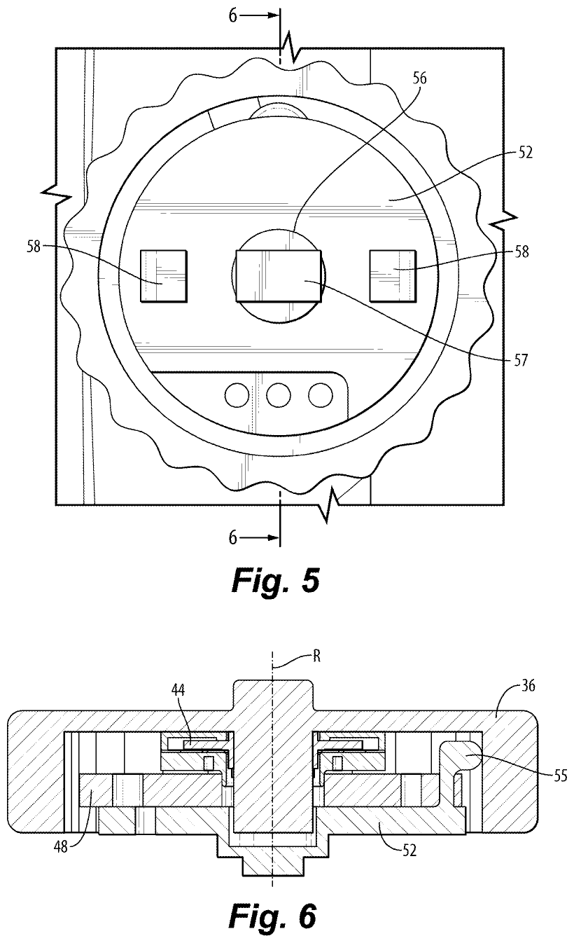

As illustrated in FIGS. 5 and 6, the support 52 further includes a cylindrical protrusion 56 extending from a bottom side of the support 52. The central recess 53 extends into the cylindrical protrusion 56. A central block 57 projects from the cylindrical protrusion 56 and lateral blocks 58 project from a bottom side of the support 52. The cylindrical protrusion 56, central block 57, and lateral blocks 58 are received by similarly shaped recesses formed by the cooperating clamshell halves 29a, 29b, and operate to secure the support 52 and prevent the support 52 from rotating when the dial case 36 rotates.

Referring to FIG. 6, the circuit board 48 and the potentiometer 44 are each accommodated within the interior of the dial case 36. The support 52 is also at least partially accommodated within the dial case 36. This provides the dial assembly 32 with a compact overall height in the direction of the rotational axis R, allowing the dial assembly 32 to fit within the limited available space at the chin portion 30 while maximizing the available surface area of the dial case 36 to facilitate manipulation by the user. In some embodiments, the dial assembly 32 has an overall height along the rotational axis R between 5 millimeters and 8 millimeters, or between 6 millimeters and 7 millimeters in some embodiments.

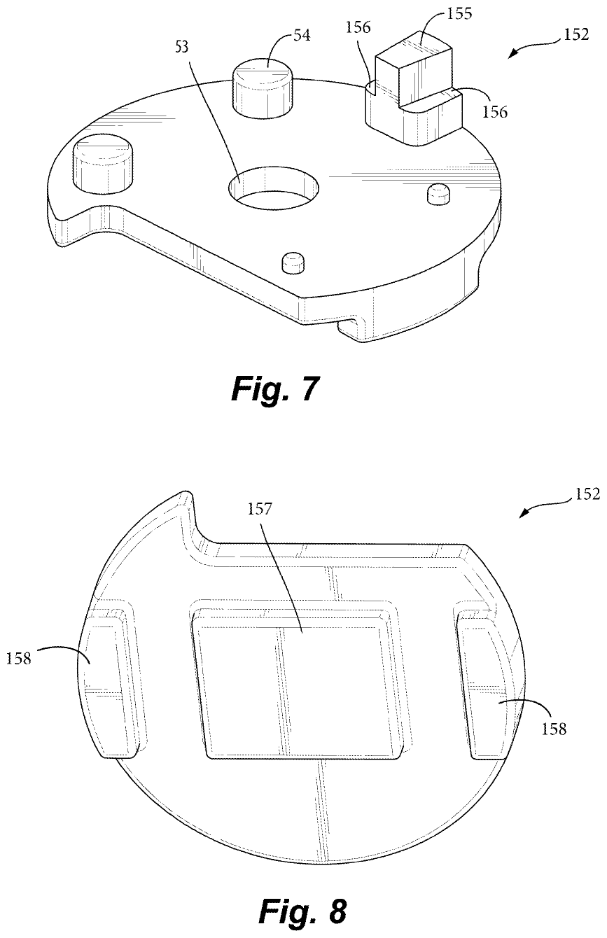

FIGS. 7 and 8 illustrate another embodiment of a support 152 for use in the dial assembly 32. The support 152 includes similar components as the support 52, with like reference numbers identifying like components. For brevity, only the differences between the support 152 and the support 52 are described. With specific reference to FIG. 7, the support 152 includes a stop tab 155 on a top side of the support 152. The stop tab 155 includes a pair of opposing cutouts 156. The cutouts 156 can be shaped to fit the stop tab 155 though the cutout 51 in the circuit board 48. With specific reference to FIG. 8, the support 152 includes a central block 157 and a pair of lateral blocks 158 on a bottom side of the support 152. The lateral blocks 158 extend to a periphery of the support 152. The central block 157 and lateral blocks 158 are received by similarly shaped recesses formed by the cooperating clamshell halves 29a, 29b, and operate to secure the support 52 and prevent the support 152 from rotating when the dial case 36 rotates.

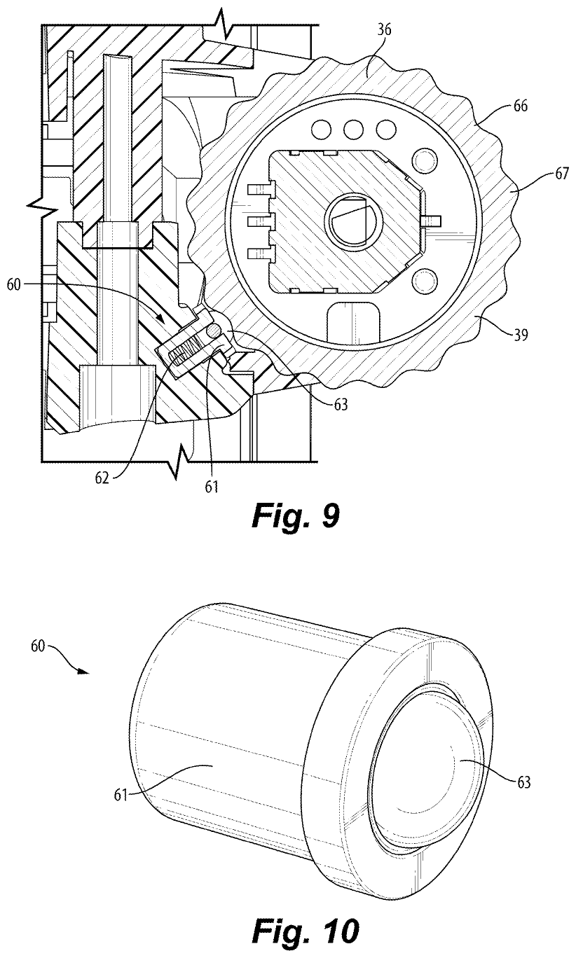

As illustrated in FIGS. 9 and 10, the outer wall 39 of the dial case 36 is contacted by a detent assembly 60. The detent assembly 60 includes a detent housing 61, a biasing member 62 (e.g., a spring) within the detent housing 61, and a ball 63 supported by the detent housing 61 and biased by the biasing member 62. The ball 63 is in contact with the outer wall 39 and is pushed into the detent housing 61 against the bias of the biasing member 62 by the outer wall 39. As the dial case 36 is rotated, the ball 63 is pushed different distances into the detent housing 61. For example, the ball 63 is pushed into the detent housing 61 a first distance when the ball 63 is in contact with one of a plurality of trough portions 66 on the outer wall 39, and the ball 63 is pushed into the detent housing 61 a second distance greater than the first distance when the when the ball 63 is in contact with one of a plurality of ridge portions 67 on the outer wall 39. Thus, to rotate the dial case 36 from one of the plurality of trough portions 66 to another of the plurality of trough portions 66, the user must overcome the force required to push the ball 63 against the bias of the biasing member 62 the distance between the second distance and the first distance. The ball 63 is configured to remain at rest in the trough portions 66, and the trough portions 66 may correspond to a specific torque setting. Rotation of the dial case 36 against the bias of the biasing member 62 may also provide tactile feedback. This will alert the user the torque setting has been switched from one level to another. The torque setting may also be indicated by a display, lights, or the like. In some embodiments, there may be a plurality of LED's used to display the torque setting.

During operation, the user rotates the dial case 36 about the rotational axis R. The second portion 38b and the central aperture 45 of the potentiometer 44 are shaped similarly, such that the flat side 43 of the second portion 38b contacts the flat side 46 of the potentiometer 44 to cause the potentiometer 44 to rotate with the dial case 36. Electronic signals (e.g., in the form of a varying resistance, current, or voltage) are sent to a control system in response to rotation of the potentiometer 44 to adjust a torque setting of the power tool 10. The control system may include a micro-processor and other electrical/electronic components mounted on the circuit board 48 or located elsewhere within the power tool 10.

For example, the control system may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. “Control systems,” “controllers,” etc., described herein can include one or more processing units, one or more computer-readable medium modules, one or more input/output interfaces, and various connections (e.g., a system bus) connecting the components.

The circuit board 48 and the support 52 remain stationary as the dial case 36 rotates. The block 42 is configured to contact the stop tab 55, which prevents the dial case 36 from rotating in a full revolution. As such, the illustrated dial case 36 has a maximum rotational travel that is less than 360 degrees. In some embodiments, when the dial case 36 is rotated such that a first side of the block 42 contacts a first side of the stop tab 55, the torque setting will be at a maximum, and when the dial case 36 is rotated such that a second side of the block 42 opposite the first side of the block 42 contacts a second side of the stop tab 55 opposite the first side of the stop tab 55, the torque setting will be at a maximum, or vice versa. In some embodiments, there may not be a block, which will allow the dial case 36 to freely revolve about the rotational axis R. In such embodiments, maximum and minimum limits on the torque setting may be set by software.

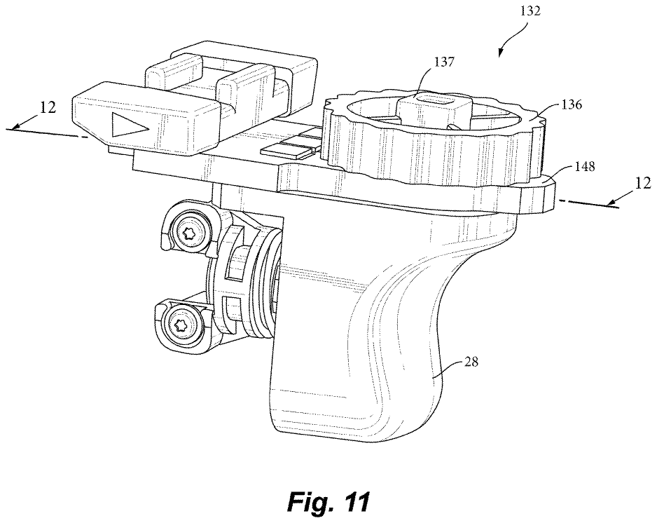

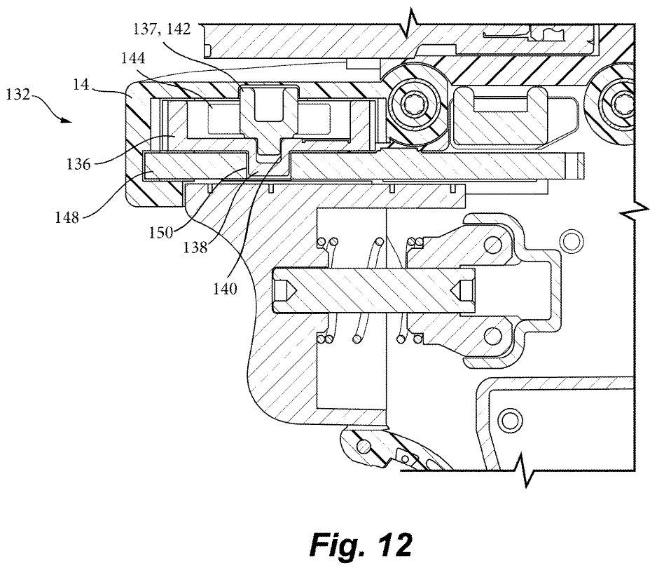

FIGS. 11 and 12 illustrates another embodiment of a dial assembly 132 for use in the power tool 10. The dial assembly 132 includes similar components as the dial assembly 32, with like reference numbers identifying like components. For brevity, only the differences between the dial assembly 132 and the dial assembly 32 are described. The dial assembly 132 includes a dial case 136, a detent 137, and a circuit board 148. With specific reference to FIG. 12, the dial case 136 includes a central post 138 extending from a lower surface of the dial case 136. The central post 138 defines a central recess 140 on an inner surface of the dial case 136. The detent 137 includes a base 142 and a plurality of arms 144 projecting radially from the base 142. The detent 137 is positioned within the dial case 136. More specifically, the base 142 is received in the central recess 140. The arms 144 contact an undulating inner surface of the dial case 136. In some embodiments, the detent 137 can be coupled to the housing 14 such that the dial case 136 is configured to rotate relative to the arms 144. In these embodiments, the arms 144 can provide resistance to the dial case 136, such that it requires more force to rotate the dial case 136 relative to the detent 137. The arms 144 can additionally or alternatively provide tactile feedback as the undulating inner surface of the dial case 136 moves along the arms 144. In other embodiments, the detent 137 can be rotatably coupled to the housing such that the dial case 136 rotates with the arms 144. In yet other embodiments, the detent 137 can be integrally formed with the dial case 136 as a single piece.

In the illustrated embodiment, the circuit board 148 is positioned below the dial case 136. Stated another way, the circuit board 148 is positioned between the dial case 136 and the trigger 28. The circuit board 148 includes an aperture 150. The central post 138 is received in the aperture 150. The central post 138 (and thus the dial case 136) is configured to rotate relative to the circuit board 148. The rotation of the dial case 136 adjusts the torque setting of the power tool 10. More specifically, rotation of the dial case 136 sends signals to the circuit board 148 to adjust the torque setting of the power tool 10. In some embodiments, a potentiometer can be positioned within the dial case 136. The potentiometer can send signals to the circuit board 148 as the dial case 136 rotates. In other embodiments, the circuit board 148 can include integral rotational sensors that are configured to measure rotation of the dial case 136 relative to the circuit board 148.

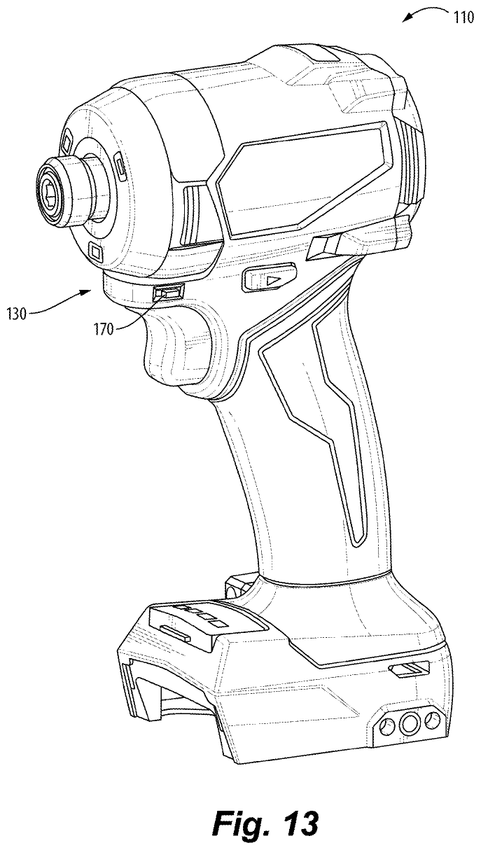

FIG. 13 illustrates a power tool 110 including a torque adjustment interface according to another embodiment. The power tool 110 may include any combination of features from the preceding embodiment (and vice versa), but only features of the power tool 110 not yet discussed with respect to the previous embodiment are detailed below.

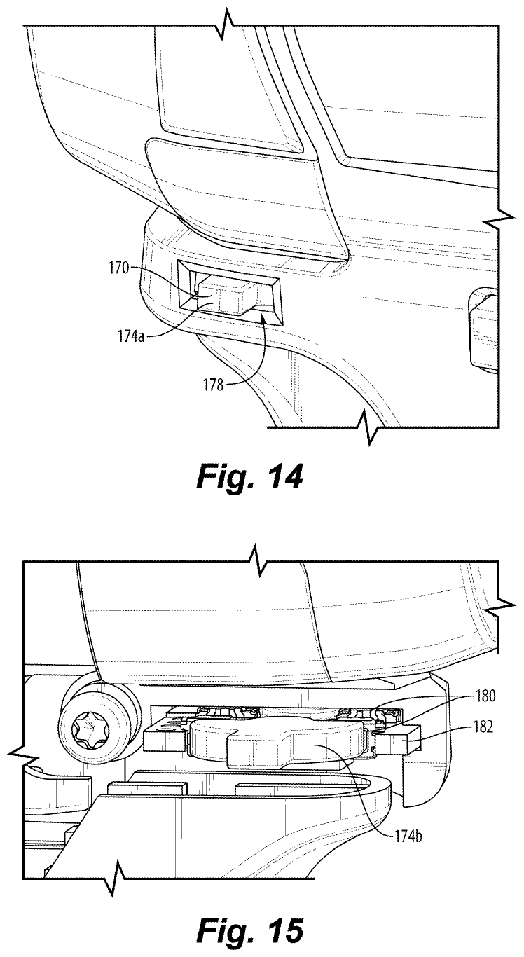

As illustrated in FIGS. 13-15, the torque adjustment interface of the power tool 110 includes a rocker switch 170 disposed in a chin portion 130 of the power tool 110. The rocker switch 170 includes a first tab 174a and a second tab 174b. The first and second tabs 174a, 174b extend out of recesses 178 in opposite lateral sides of the chin portion 130 and are operable to contact switches 180 disposed on a circuit board 182. As discussed below, the switches 180 are operable to change the torque setting of the power tool 110.

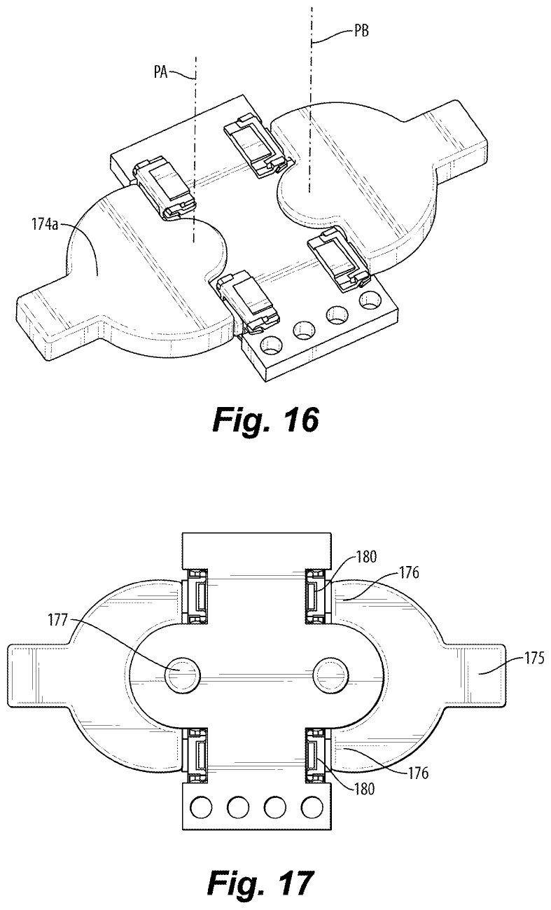

As illustrated in FIGS. 16 and 17, the first tab 174a is pivotable about a first pivot axis PA and the second tab 174b is pivotable about a second pivot axis PB (each of which may extend through the trigger and front housing portion of the power tool 110). The tabs 174a, 174b include protruding portions 175 that extend out of the recesses 178 and contacting portions 176 that contact the switches 180. During operation, the user pivots one of the protruding portions 175 about one of the pivot axes PA, PB, which leads to one of the contacting portions 176 contacting one of the switches 180 to change the torque setting of the power tool 110. The user may pivot one of the protruding portions 175 toward the front of the power tool 110, which leads to the torque setting being incremented in a first direction (i.e., increased or decreased). The user may also pivot one of the protruding portions 175 toward a rear of the power tool 110, which leads to the torque setting being incremented in a second direction opposite the first direction. In some embodiments, the switches 180 may be configured such that the pivoting of either of the tabs 174a, 174b in a clockwise direction leads to the torque setting being adjusted in the first direction and the pivoting of either of the tabs 174a, 174b in a counterclockwise direction leads to the torque setting being adjusted in the second direction.

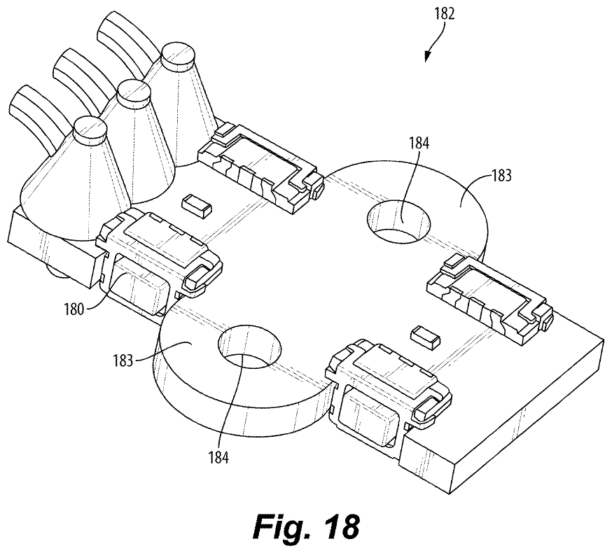

As illustrated in FIG. 18, the circuit board 182 includes ear portions 183 adjacent switches 180 with apertures 184 extending through. The apertures 184 are configured to receive bosses 177 (FIG. 17) extending from the tabs 174a, 174b, providing a pivotal connection between the circuit board 182 and the tabs 174a, 174b.

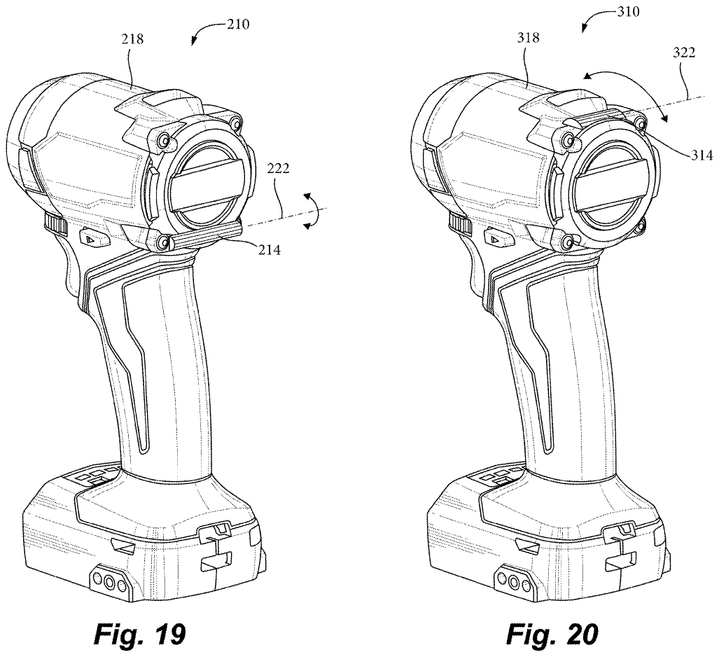

FIG. 19-31 illustrate power tools 210, 310, 410, 510, 610, 710, 810, 910, 1010, 1110, 1210, 1310, 1410 that respectively include torque adjustment interfaces 214, 314, 414, 514, 614, 714, 814, 914, 1014, 1114, 1214, 1314, 1414 according to further embodiments. The power tools 210, 310, 410, 510, 610, 710, 810, 910, 1010, 1110, 1210, 1310, 1410 may include any combination of features from the preceding embodiments (and vice versa), but only features of the power tool 210, 310, 410, 510, 610, 710, 810, 910, 1010, 1110, 1210, 1310, 1410 not yet discussed with respect to the previous embodiment are detailed below.

With reference to FIG. 19, the torque adjustment interface 214 is positioned on a rear side of a motor housing portion 218 of the power tool 210. The torque adjustment interface 214 is rotatable about a rotational axis 222 to adjust a torque setting of the power tool 210.

With reference to FIG. 20, the torque adjustment interface 314 is positioned on a rear side of a motor housing portion 318 of the power tool 310. The torque adjustment interface 314 is rotatable about a rotational axis 322 to adjust a torque setting of the power tool 310.

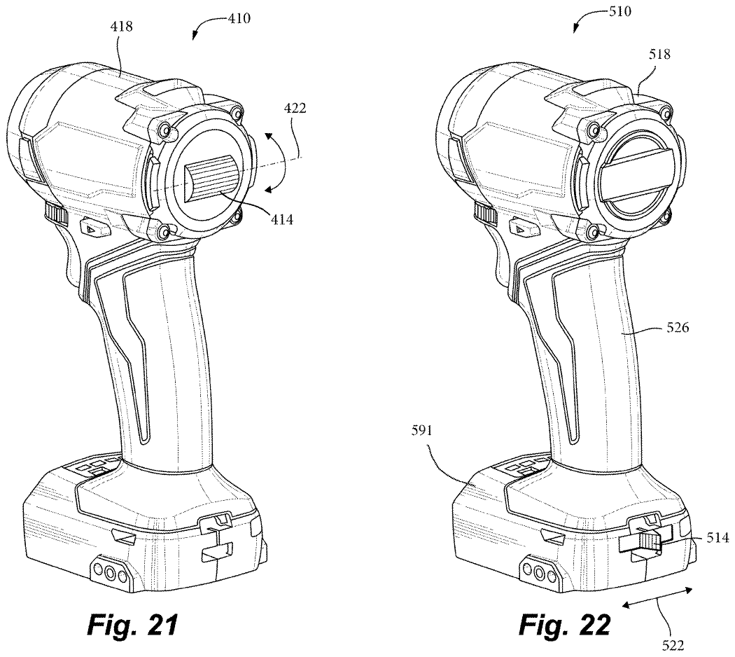

With reference to FIG. 21, the torque adjustment interface 414 is positioned on a rear side of a motor housing portion 418 of the power tool 410. The torque adjustment interface 414 is rotatable about a rotational axis 422 to adjust a torque setting of the power tool 410.

With reference to FIG. 22, the torque adjustment interface 514 is positioned on a rear side of a foot 591 of the power tool 510. The foot 591 may include the battery receptacle and is located at an end of the handle portion 526 opposite the motor housing portion 518 of the power tool 510. The torque adjustment interface 514 is slidable in an adjustment direction 522 to adjust a torque setting of the power tool 510.

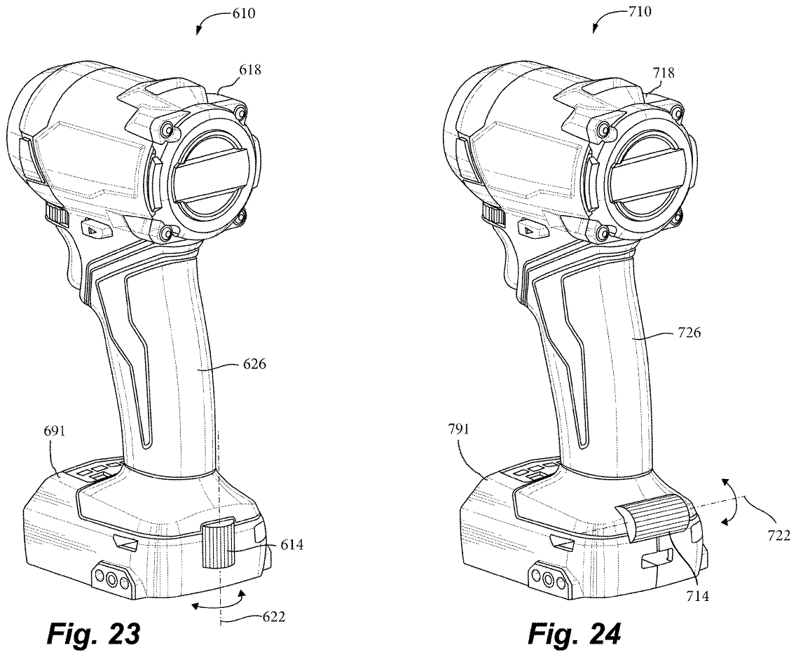

With reference to FIG. 23, the torque adjustment interface 614 is positioned on a rear side of a foot 691 of the power tool 610. The foot 691 may include the battery receptacle and is located at an end of the handle portion 626 opposite the motor housing portion 618 of the power tool 610. The torque adjustment interface 614 is rotatable about a rotational axis 622 to adjust a torque setting of the power tool 610.

With reference to FIG. 24, the torque adjustment interface 714 is positioned on a rear side of a foot 791 of the power tool 710. The foot 791 may include the battery receptacle and is located at an end of the handle portion 729 opposite the motor housing portion 718 of the power tool 710. The torque adjustment interface 714 is rotatable about a rotational axis 722 to adjust a torque setting of the power tool 710.

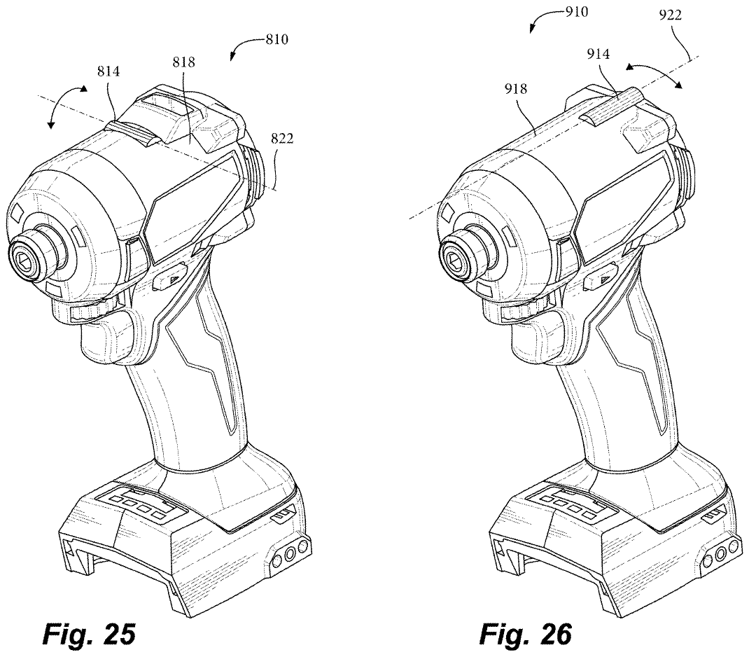

With reference to FIG. 25, the torque adjustment interface 814 is positioned on an upper side of a motor housing portion 818 of the power tool 810. The torque adjustment interface 814 is rotatable about a rotational axis 822 to adjust a torque setting of the power tool 810.

With reference to FIG. 26, the torque adjustment interface 914 is positioned on an upper side of a motor housing portion 918 of the power tool 910. The torque adjustment interface 914 is rotatable about a rotational axis 922 to adjust a torque setting of the power tool 910.

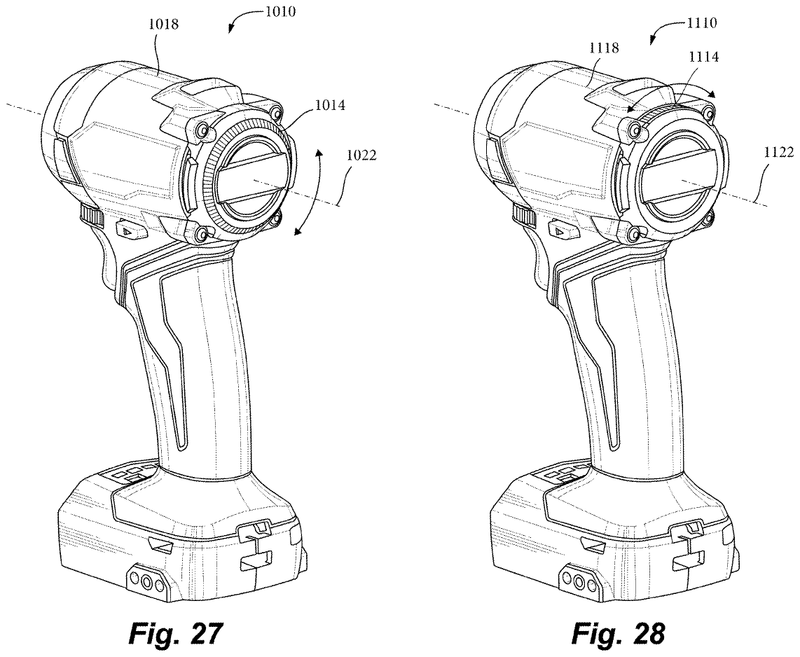

With reference to FIG. 27, the torque adjustment interface 1014 is positioned on a rear side of a motor housing portion 1018 of the power tool 1010. The torque adjustment interface 1014 is rotatable about a rotational axis 1022 to adjust a torque setting of the power tool 1010.

With reference to FIG. 28, the torque adjustment interface 1114 is positioned on a rear side of a motor housing portion 1118 of the power tool 1110. The torque adjustment interface 1114 is rotatable about a rotational axis 1122 to adjust a torque setting of the power tool 1110.

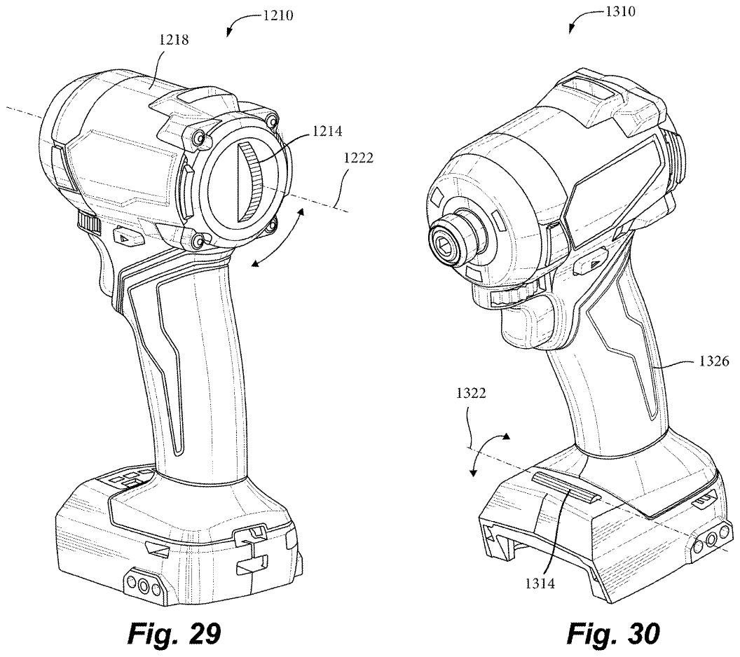

With reference to FIG. 29, the torque adjustment interface 1214 is positioned on a rear side of a motor housing portion 1218 of the power tool 1210. The torque adjustment interface 1214 is rotatable about a rotational axis 1222 to adjust a torque setting of the power tool 1210.

With reference to FIG. 30, the torque adjustment interface 1314 is positioned on a front side of a handle portion 1326 of the power tool 1310. The torque adjustment interface 1314 is rotatable about a rotational axis 1322 to adjust a torque setting of the power tool 1310.

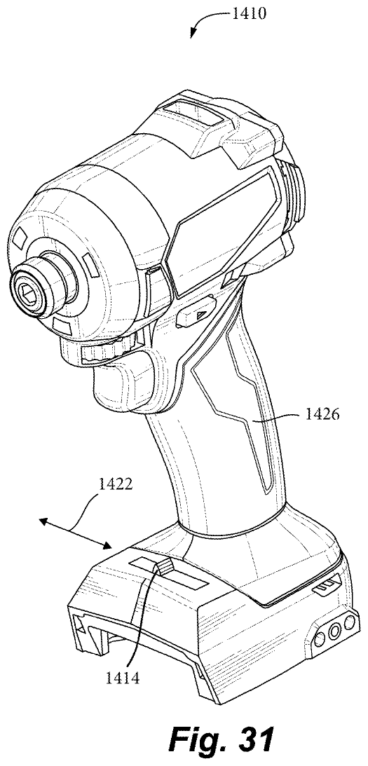

With reference to FIG. 31, the torque adjustment interface 1414 is positioned on a front side of a handle portion 1426 of the power tool 1410. The torque adjustment interface 1414 is slidable in an adjustment direction 1422 to adjust a torque setting of the power tool 1410.

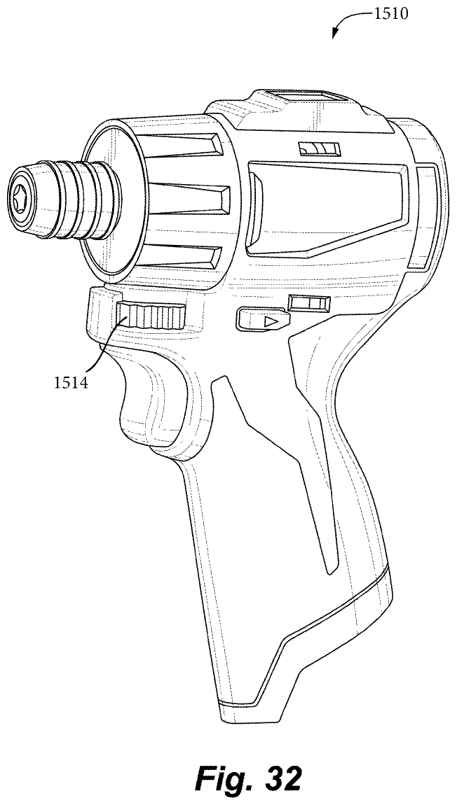

FIG. 32 illustrates a power tool 1510 in the form of a powered screwdriver. The power tool 10 includes a torque adjustment interface 1514. The power tool 1510 may include any combination of features from the preceding embodiments.

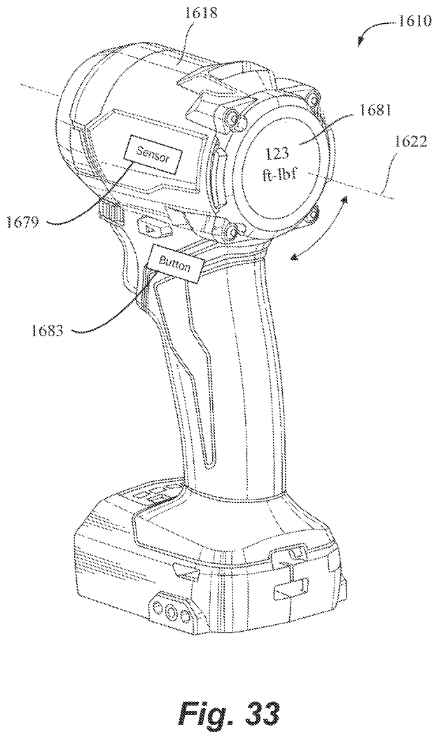

FIG. 33 illustrates a power tool 1610, which may be an impact driver, a drill, a powered screwdriver, or the like. The illustrated power tool 1610 may include any of the torque adjustment interfaces described above. Additionally or alternatively, the power tool 1610 may include a torque adjustment interface incorporating one or more acceleration sensors 1679, such as an accelerometer or inertial measuring unit (IMU) supported on or within a housing 1618 of the power tool 1610, and an actuator, such as a pushbutton 1683. In use, to adjust the torque setting of the power tool 1610, the user first actuates the pushbutton 1683 (e.g., by depressing the pushbutton 1683, and optionally holding down the pushbutton 1683 either continuously or for at least a predetermined time period), which communicates with the control system of the power tool 1610 to place the power tool 1610 in a torque setting mode.

Once in the torque setting mode, the user may rotate the housing 1618 about an output axis 1622 of the power tool 1610 (i.e., the rotational axis of the output member). The sensor 1679 detects this rotation (e.g., as a deviation from an initial orientation) and communicates a signal corresponding to the detected rotation to the control system of the power tool 1610, which may then adjust the torque setting of the clutch mechanism. In one embodiment, rotation of the power tool 1610 in a first direction (e.g., clockwise) about the axis 1622 causes the control system to increase the torque setting, and rotation of the power tool 1610 in a second, opposite direction (e.g., counter-clockwise) about the axis 1622 causes the control system to decrease the torque setting.

In some embodiments, the rate of increase or decrease in torque setting may be proportional or otherwise functionally related to the degree or magnitude of rotation of the power tool 1610 about the axis 1622. For example, the torque setting may increase or decrease by X units per second, where X is equal to the number of degrees of rotation about the axis 1622 relative to a starting orientation of the power tool 1610 or a predetermined orientation of the power tool 1610, such as the upright orientation illustrated in FIG. 33.

In the illustrated embodiment, the power tool 1610 includes a display 1681 for displaying the torque setting to the user. The illustrated display 1681 is located on a back side the housing 1618 (e.g., the back side of the motor housing portion), but the display 1681 may be located elsewhere on the housing 1618 in other embodiments. The display 1681 may be an LCD or other suitable display capable of indicating one or more numbers representative of the torque setting. In other embodiments, the display 1681 may change colors to indicate the torque setting.

The control system may update the display 1681 during adjustment of the torque setting so that the user may rotate the power tool 1610 back to its initial position and stop adjustment of the torque setting when the desired torque setting is reached. In some embodiments, the user may additionally or alternatively actuate the pushbutton 1683 (such as by depressing the pushbutton 1683 a second time or releasing the pushbutton 1683) to accept and stop further adjustment of the torque setting. In some embodiments the control system may pulse the motor of the power tool 1610 or control a separate haptic feedback mechanism as a function of the rate of torque adjustment to provide haptic feedback to the user that torque adjustment is occurring and at what rate torque adjustment is occurring.

Although the disclosure has been described in detail with reference to certain preferred embodiments, variations and modifications exist within the scope and spirit of one or more independent aspects of the disclosure as described.

Various features of the disclosure are set forth in the following claims.

What is claimed is:

1. A power tool comprising:
a housing including
a motor housing portion,
a front housing portion coupled to the motor housing portion, and
a handle portion extending from the motor housing portion;
a trigger coupled to a front side of the handle portion;
an output member extending from the front housing portion; and
a torque adjustment interface disposed between the front housing portion and the trigger, the torque adjustment interface including an actuator rotatable in a first direction to increase a torque output limit of the power tool and in a second direction opposite the first direction to decrease the torque output limit of the power tool.

2. The power tool of claim 1, wherein the actuator includes a rotatable dial case, and wherein the torque adjustment interface further includes a circuit board.

3. The power tool of claim 2, wherein the circuit board is positioned within the dial case.

4. The power tool of claim 2, wherein the circuit board is positioned between the dial case and the trigger.

5. The power tool of claim 2, further comprising a potentiometer positioned within the dial case, wherein the potentiometer is configured to rotate with the dial case, and wherein the potentiometer is configured to send signals to the circuit board in response to rotation of the potentiometer.

6. The power tool of claim 5, wherein
the circuit board includes an aperture,
the dial case includes a post, and
the post is received in the aperture and configured to rotate relative to the aperture.

7. The power tool of claim 2, wherein
the torque adjustment interface further includes a support positioned within the dial case,
the support includes an arm in contact with an inner surface of the dial case, and
the arms is configured to provide tactile feedback as the dial case rotates relative to the support.

8. The power tool of claim 2, further comprising a detent assembly disposed in the housing and configured to contact an outer wall of the dial case to resist rotation of the dial case.

9. The power tool of claim 8, wherein
the detent assembly includes a detent housing, a biasing member positioned in the detent housing, and a ball positioned within the detent housing and biased by the biasing member,
the ball is configured to contact the outer wall of the dial case, and
rotation of the dial case is configured to move the ball against a bias of the biasing member.

10. The power tool of claim 1, wherein the housing includes a first clamshell defining a first lateral side of the housing and a second clamshell defining a second lateral side of the housing, and wherein the actuator is accessible from both the first lateral side and the second lateral side.

11. The power tool of claim 1, wherein the actuator includes a rocker switch.

12. The power tool of claim 1, further comprising
a motor supported within the motor housing portion;
a drive assembly supported within the motor housing portion and driven by the motor; and
an impact assembly coupled to an output of the drive assembly, the impact assembly operable to deliver periodic rotational impacts to the output member,
wherein the impact assembly is supported within the front housing portion.

13. A power tool comprising:
a housing including
a motor housing portion,
a front housing portion coupled to the motor housing portion, and
a handle portion extending from the motor housing portion;
a motor supported within the motor housing portion;
a drive assembly supported within the motor housing portion and driven by the motor;
an impact assembly coupled to an output of the drive assembly, the impact assembly operable to deliver periodic rotational impacts to an output member extending from the front housing portion; and
a torque adjustment interface including an actuator rotatable in a first direction to increase a torque output limit of the power tool and in a second direction opposite the first direction to decrease the torque output limit of the power tool.

14. The power tool of claim 13, wherein the torque adjustment interface includes a circuit board, and wherein the actuator includes a portion extending through the circuit board.

15. The power tool of claim 14, wherein the torque adjustment interface includes a potentiometer coupled for co-rotation with the actuator.

16. The power tool of claim 13, wherein the actuator includes a rocker switch.

17. The power tool of claim 13, wherein the housing includes a first clamshell defining a first lateral side of the housing and a second clamshell defining a second lateral side of the housing, and wherein the actuator is accessible from both the first lateral side and the second lateral side.

18. The power tool of claim 13, wherein the actuator is located at a position selected from a group consisting of:
a rear side of the motor housing portion opposite the front housing portion,
a foot of the housing disposed at an end of the handle portion opposite the motor housing portion,
a top side of the motor housing portion opposite the handle portion, and
a chin portion of the housing below the front housing portion and above a trigger of the power tool.

19. A power tool comprising:
a housing including
a motor housing portion,
a front housing portion coupled to the motor housing portion, and
a handle portion extending from the motor housing portion;
a motor supported within the motor housing portion;
an output member extending from the front housing portion and rotatable about an axis;
a torque adjustment interface including an acceleration sensor; and
a control system configured to
detect rotation of the housing about the axis based on feedback from the acceleration sensor,
increase a torque output limit of the power tool if the housing is rotated about the axis in a first direction, and
decrease a torque output limit of the power tool if the housing is rotated about the axis in a second direction opposite the first direction.

20. The power tool of claim 19, wherein the control system is configured to increase or decrease the torque output limit at a rate proportional to a magnitude of the detected rotation.
